(19) United States
(12) Patent Application Publication
(10) Pub. No.: US 2025/0263859 A1
(43) Pub. Date: Aug. 21, 2025

(54) METHOD OF PRODUCING H2 AND/OR BR2 BY ELECTROLYSING HBr USING FLUOROPOLYMER MEMBRANES

(71) Applicant: TOTALENERGIES ONETECH, Courbevoie (FR)

(72) Inventors: Miroslav KETTNER, Seneffe (BE); Gleb VERYASOV, Seneffe (BE); Thomas TUREK, Clausthal-Zellerfeld (DE); Ulrich KUNZ, Clausthal-Zellerfeld (DE); Heiner GRIMM, Clausthal-Zellerfeld (DE)

(21) Appl. No.: 18/998,062

(22) PCT Filed: Jul. 24, 2023
(86) PCT No.: PCT/EP2023/070469

§ 371 Date: Jan. 23, 2025

(30) Foreign Application Priority Data
Jul. 25, 2022 (EP) 22315171.3
Jul. 25, 2022 (EP) 22315172.1

(51) Int. Cl. C25B 13/08; C25B 1/02; C25B 1/24

(52) U.S. Cl. CPC C25B 13/08; C01B 7/093; C01B 17/69; C25B 1/04; C25B 1/24; C25B 9/23

(57) ABSTRACT

A method of producing hydrogen and/or bromine by electrolysing hydrogen bromide using a fluoropolymer membrane having a glass transition temperature T_{g}≥110° C. in an electrolysis of hydrogen bromide, wherein the hydrogen bromide stems from a sulfuric acid synthesis.

### TECHNICAL FIELD

The disclosure relates to a method of producing hydrogen and/or bromine by electrolysing hydrogen bromides. The disclosure also relates to the uses of fluoropolymer membranes in an electrolysis of hydrogen bromide after sulfuric acid synthesis, to gases obtained by such uses and corresponding methods.

### BACKGROUND OF THE DISCLOSURE

The global demand for hydrogen (H₂) and H₂-derived fuels will significantly increase in the coming years. This is inter alia because H₂ is expected to play a key role in mitigating global warming. In order to produce H₂ in an eco-friendly manner, water electrolysis using renewable electricity is nowadays a standard technology, and the hydrogen produced thereby is also called green hydrogen. There are basically three technologies to accomplish water electrolysis, namely alkaline electrolysis (AEL), proton exchange membrane electrolysis (PEMEL), and solid oxide electrolysis (SOEL).

The different technologies have different operation ranges and different efficiencies. SOEL technology is for example a high-temperature solution that typically offers comparably high efficiencies. However, SOEL solutions typically have a rather limited lifetime and require relatively high capital expenditures (CAPEX) in combination with generally lower technology readiness levels. AEL is the oldest technology but is less flexible than PEMEL and does not allow for regulation of power over a comparably broad range. Further, AEL solutions regularly suffer from disadvantageously low current densities, which in turn increase the CAPEX. In contrast, PEMEL solutions can typically be operated at higher current densities, which brings reductions in CAPEX. As a result, PEMEL is generally favoured for water electrolysis to produce green hydrogen.

However, liquid-phase water electrolysis typically requires a rather high threshold voltage and requires comparably high energy amounts to electrolyze the water so as to produce H₂. More specifically, water electrolysis following the reaction 2H₂O→O₂+2H₂ has a threshold voltage of 1.23 V. Alternative electrolysis routes to H₂ have thus been considered. For example, electrolysis of hydrogen halogenides could provide an alternative. Of the conceivable electrolyses, electrolysis of HBr (or HBr electrolysis) occurs rarely and is much less common compared to an electrolysis of either hydrogen chloride (HCl) or hydrogen fluoride (HF). On an industrial level, the only relevant practical application of HBr electrolysis is in flow batteries with the objective to store energy. Such flow batteries do however produce neither H₂ nor bromine (Br₂) for subsequent use thereof, but these compounds are rather used as energy carriers and are often even conserved in an impurified form which is sufficient for storage but is regularly not sufficiently pure for a subsequent use of the H₂. Further, in flow batteries the electrolysis is regularly performed under mild conditions in liquid phase to avoid pressure increase and/or damage of the membrane, and often runs at a limited conversion level to avoid the formation of several phases and any inhomogeneity in the system.

An HBr electrolysis under more severe conditions is described in U.S. Pat. No. 10,472,721 B1, but only in the context of the bromination of hydrogen sulfide. As an apparatus for such electrolysis, a standard proton exchange membrane (PEM) or a diaphragm cell are generally considered, wherein Nafion® membranes are mentioned in the context of the former. No characteristics like glass transition temperatures (T_{g}) of those membranes are reported, but the T_{g} of Nafion® is usually reported to be in the range of 98 to 109° C., depending on its hydration level (see for example Jung et al., Int. J. Hydrogen Energy 37, 12580-12585, 2012). Moreover, standard Nafion® membranes regularly suffer from accelerated degradation at elevated temperatures like above 65° C. in long-term industrial operations, and they are regularly not suitable at temperatures above 100° C. due to irreversible structural changes in the polymer forming the membrane. Due to the required lower operational temperatures, the conductivity of such membranes is limited, applicable current densities are lower, and higher operational voltages are required, making the electrolysis less economical.

Overall, there remains a general desire for improved HBr electrolysis.

It is an object of the present disclosure to provide a means for improving HBr electrolysis which at least partially overcomes the drawbacks encountered in the art. It is in particular an object of the present disclosure to provide a means for allowing HBr electrolysis at higher current densities and/or at lower operational voltages. It is furthermore an object of the present disclosure to provide a means which makes HBr electrolysis more economical. It is moreover an object of the present disclosure to provide a means for valorising HBr which is produced as a side product. It is additionally an object of the present disclosure to provide a means for improving HBr electrolysis which helps to mitigate global warming. It is also an object of the present disclosure to provide hydrogen which at least partially overcomes the drawbacks encountered in the art. It is also an object of the present disclosure to provide bromine which at least partially overcomes the drawbacks encountered in the art. It is also an object of the present disclosure to provide a method of producing hydrogen and/or bromine which at least partially overcomes the drawbacks encountered in the art.

### SUMMARY

Surprisingly, it has been found that the problem underlying the disclosure is overcome by uses (as means), hydrogen, bromine, and methods according to the claims. Further embodiments of the disclosure are outlined throughout the description.

In an aspect, the disclosure provides for the use of a fluoropolymer membrane having a glass transition temperature T_{g}≥110° C., preferably T_{g}≥120° C., more preferably T_{g}≥125° C., in the electrolysis of hydrogen bromide, wherein the hydrogen bromide stems from a sulfuric acid synthesis.

As used herein, a (fluoropolymer) membrane is a sheet or layer which can be used in standard electrolysis cells (or electrolytic cells) as a proton exchange membrane. Accordingly, protons can migrate through such a membrane. The used membrane is thus a proton exchange fluoropolymer membrane.

A fluoropolymer membrane in the use according to the present disclosure comprises a fluoropolymer, hence it is termed a fluoropolymer membrane. Preferably, the fluoropolymer membrane (in a dry state) consists of the fluoropolymer, more preferably consists of the fluoropolymer in a chemically stabilized form.

As used herein, a fluoropolymer is a fluorocarbon-based polymer with multiple carbon-fluorine bonds. Such a fluoropolymer is regularly free of silicon atoms. Such a fluoropolymer may further be free of chlorine, bromine and/or iodine atoms.

As used herein, the glass transition temperature (or T_{g}), is determined according to DIN EN ISO 11357-2:2020-08 (half-step-height method). Accordingly, as used herein, the glass transition temperature of the fluoropolymer membrane is determined by a differential scanning calorimetry (DSC) measurement, more specifically from a curve obtained by such a DSC measurement. The glass transition temperature of the fluoropolymer membrane is determined on a sample of the fluoropolymer membrane, more specifically on a sample of the fluoropolymer membrane in the fully hydrated state. According to the present disclosure, a fluoropolymer membrane in a fully hydrated state is a fluoropolymer membrane that does not take up any further (deionized) water (deionized H₂O, as described in ASTM D5127-13 (2018) standard) at a temperature of 80° C. after 24 hours, which is hence a fully hydrated fluoropolymer membrane, or a fluoropolymer membrane saturated with water. Hence, the water uptake of the fluoropolymer membrane has reached its maximum. A fully hydrated fluoropolymer membrane is obtained by immersing the fluoropolymer membrane in deionized water which will result in a weight gain of the fluoropolymer membrane as measurable by a balance. When there is no weight gain over time anymore, the fluoropolymer membrane is in a fully hydrated state. A fluoropolymer membrane in the fully hydrated state is regularly obtained by immersing the fluoropolymer membrane in deionized water having a temperature of 80° C. for a time period of 24 hours.

In some reports, glass transition temperatures of dried membranes are reported (for example in Jung et al., Int. J. Hydrogen Energy 37, 12580-12585, 2012). However, in such a dry state, the membranes show only poor conductivity. During the hydration of the membrane, the T_{g} of the membrane typically decreases drastically because of the plasticizer effect of water. According to the present disclosure, the T_{g} of the fluoropolymer membrane in the fully hydrated state is relied on because this T_{g} of the fully hydrated state reflects best the behaviour of a membrane during electrolysis, in particular during electrolysis of hydrogen bromide.

Apart from the glass transition temperature (T_{g)}, other characteristics of the fluoropolymer membrane reported herein refer to the fluoropolymer membrane in a dry state.

As used herein, the glass transition temperature (T_{g)}refers to the lowest glass transition temperature of the fluoropolymer. It is known that certain polymers or membranes made of polymers, respectively, e.g., Nafion®-type membranes, may have several glass transition temperatures, in particular two glass transition temperatures. The first glass transition temperature is due to the mobility of the main chain in the polymer matrix, while the second glass transition temperature is due to side chain effects, especially effects associated with strong interactions of functional groups in such side chains like sulfonic acid groups. Once the first glass transition temperature has been reached, the membrane undergoes irreversible changes and can in particular not be used for an electrolysis process anymore. Accordingly, in the context of the present disclosure, if a material, especially a membrane or a membrane sample, exhibits several glass transition temperatures, only the lowest T_{g} is relevant for the T_{g} definitions provided herein.

Any use according to the present disclosure can also be seen as a corresponding method of using.

The concept “OPEX” means “operational expenditures”, and is expressed herein in units of surface power density (W/m²). This is the result of the multiplication of the operational voltage (in mV) of an electrolytic cell by the applied current density (in kA/m²) (Uₒₚ×Jₒₚ).

As used herein, electrolysis of hydrogen bromide (or electrolysis of HBr; or HBr electrolysis) refers to an electrolytic split of HBr into hydrogen and a bromine species (Br₂ and/or Br₃⁻) by applying an external voltage to the electrodes of an electrolysis cell to which the HBr is fed, more specifically fed to the anode of such an electrolysis cell.

As used herein, hydrogen bromide which stems from (originates from; is produced in) a sulfuric acid synthesis is a side product of a reaction in which sulfuric acid (H₂SO₄) is synthesized. Such a reaction may also be referred to as the synthesis of sulfuric acid (or of H₂SO₄) or simply H₂SO₄ synthesis. FIG. 5 shows preferred routes for producing hydrogen bromide in a sulfuric acid synthesis:

Accordingly, it is preferred that in a use according to the present disclosure, the HBr is coming from an interaction of H₂S, S, or SOₓ (x being in particular 2) with Br₂ and water (H₂O). The following conversion reactions are particularly preferred:

H₂S+4Br₂+4H₂O→H₂SO₄+8HBr

S+3Br₂+4H₂O→H₂SO₄+6HBr

SO₂+Br₂+2H₂O→H₂SO₄+2HBr

As seen above, the HBr is a side product of sulfuric acid synthesis.

When step i) only comprises providing a stream containing hydrogen bromide obtained from the synthesis of sulfuric acid, said stream will comprises traces of sulfur-based compounds such as H₂SO₄, H₂S, S, and/or SOₓ (x being in particular 2). The presence of sulfur-based compounds in the stream containing hydrogen bromide obtained from the synthesis of sulfuric acid can be determined by gas chromatography.

For example, the stream containing hydrogen bromide obtained from the synthesis of sulfuric acid comprises at least 1 ppm by weight based on the total weight of the stream, of at least one selected from H₂SO₄, H₂S, S, SOₓ (x being in particular 2), and any mixture thereof.

For example, the stream containing hydrogen bromide obtained from the synthesis of sulfuric acid comprises from 1 ppm by weight to 1 wt. % based on the total weight of the stream, of at least one selected from H₂SO₄, H₂S, S, SOₓ (x being in particular 2), and any mixture thereof; for example, from 5 ppm by weight to 0.5 wt. %; or from 10 ppm by weight to 0.1 wt. %.

One way to look at HBr produced in this way is that HBr is a valuable resource that has a potential for recovering both, bromine and hydrogen. In particular, it is of interest to close the bromine loop and to recycle HBr back into Br₂. This is however typically done by thermal oxidation in which the HBr is simply burned forming Br₂ and water. Such a reaction is highly exothermic and thus needs to be carefully controlled. Moreover, the hydrogen contained in the HBr is not recovered but is rather lost. In advantageous contrast, the use according to the present disclosure can be easily controlled and can further allow for a recovery of both, H₂ and Br₂. In other words, the use according to the present disclosure can advantageously valorise HBr which is produced as a side product in a sulfuric acid synthesis, i.e., which stems from an H₂SO₄ synthesis.

Further, FIG. 6 summarizes a typical reaction sequence that yields valuable hydrogen by converting a sulfur(S)-containing and potentially nitrogen(N)-containing feedstream via an oxidation with bromine to give at least H₂SO₄ and HBr and a subsequent electrochemical splitting of HBr (HBr electrolysis) into hydrogen and (not shown) bromine.

FIG. 6 demonstrates that the use according to the present disclosure allows for producing hydrogen from otherwise polluting raw materials like H₂S, S, SOₓ, and NOₓ, which hydrogen can play the desired role in mitigating global warming.

Additionally, the use according to the present disclosure can allow for HBr electrolysis at higher temperatures and/or at higher pressures, because of a more resilient fluoropolymer membrane. Without wishing to be bound to theory, it is assumed that the resilience to HBr and, after electrolysis, H₂ and Br₂ at higher temperatures and also at higher pressures is imparted by the fluoropolymer membrane having a glass transition temperature of equal to or higher than 110° C. (T_{g}≥110° C.). Further, especially higher temperatures can decrease the resistance of the fluoropolymer membrane which can allow for higher proton conductivities. Higher proton conductivities can allow for higher current densities at lower operational voltages. Higher current densities can help to keep CAPEX low, while lower operational voltages lead to lower operational expenditures (OPEX), thereby making the use according to the present disclosure particularly economical. As aforesaid, such use according to the present disclosure may also produce hydrogen in an eco-friendly manner, thereby assisting in mitigating global warming. These effects can be even more pronounced when using a fluoropolymer membrane having T_{g}≥120° C. and still more pronounced when using a fluoropolymer membrane having T_{g}≥125° C.

The use according to the present disclosure can be for an HBr electrolysis which is performed in an aqueous phase or which is performed in a gaseous phase, preferably in an aqueous phase, more preferably in an aqueous phase at an operational temperature above 60° C., still more preferably in an aqueous phase at an operational temperature above 70° C. Br₂ solubility in water is rather limited but this compound is perfectly soluble in HBr in form of Br₃⁻. As soon as at least 33% of Br is present in the form of HBr, there is just one phase and no inhomogeneity in the electrochemical cell (electrolytic cell). This is a typical scenario for fuel cells, which are used for energy storage, and for safety reasons it is highly preferable to store the Br₂ in liquid solution as Br₃⁻. However, if the purpose is Br₂ recovery and production of hydrogen, a high conversion level per pass is highly desirable. The conversion level above 67% of HBr per pass without any phase separation and destabilizing of the electrolyser performance is typically not possible in aqueous phase at low temperatures, in particular not possible below the boiling temperature of Br₂ (58.8° C.). Preferably above 60° C., more preferably above 70° C., Br₂ evaporates sufficiently fast, thereby preventing the formation of a second liquid phase at high conversion level. For preferred electrolysis in the aqueous phase at above 60° C., more preferably at above 70° C., using a fluoropolymer membrane having a significantly higher T_{g} is preferred, inter alia from the viewpoint of sustainable electrolysis. Hence, for such a case it is preferred that the T_{g} is at least 30° C. and more preferably 40° C. higher than the operational temperature of the electrolysis which can lead to a particularly sustainable electrolysis.

An aqueous phase HBr electrolysis follows the reaction 2HBr+Br⁻→Br₃⁻+H₂ and has a threshold voltage of 1.10 V. A gas phase HBr electrolysis follows the reaction 2HBr→Br₂+H₂ and has a threshold voltage of 0.58 V. Considering equal losses during the electrolytic process, it is thereby seen that production of hydrogen from HBr in both aqueous and gas phases will be more energy efficient than current state-of-the-art technology for production of green hydrogen by water electrolysis. Further, while being slightly inferior in terms of threshold voltage, HBr electrolysis in an aqueous phase can lead to a safer production of hydrogen and bromine as no dangerous gaseous HBr may escape the overall electrolysis process and can lead to easier handling of the resulting bromine as this is obtained in a dissolved form.

It is preferred that in a use according to the present disclosure, the fluoropolymer membrane has a glass transition temperature T_{g} in the range of 110 to 170° C., more preferred of 120 to 170° C. and still more preferred of 125 to 170° C. As discussed herein, the HBr is a side product of a sulfuric acid synthesis. Such HBr is typically hot and would regularly have to be cooled down for a subsequent electrolysis thereof. Performing the electrolysis at increased temperatures reduces the need for such cooling down. Additionally, higher temperatures typically increase the proton conductivity of a fluoropolymer membrane, which can allow operation at higher current densities and/or at lower voltages. Higher current densities help to keep the CAPEX low. In this context, it is preferred that the electrolysis is performed above 70° C. At such temperatures, liquid-liquid phase separation can be avoided. When the fluoropolymer membrane of the inventive use has a glass transition temperature T_{g} in the range of 110 to 170° C., more preferred in the range of 120 to 170° C. and still more preferred in the range of 125 to 170° C. the operational temperature of the HBr electrolysis may be maintained at >70° C., more specifically at >90° C., especially at >100° C., which can allow for a good balance between the above-discussed advantages of higher operational temperatures on the one hand and of lower operational temperatures on the other hand.

For the above reasons, it is also preferred that the HBr electrolysis occurs in the use according to the present disclosure at an operational temperature of >70° C., more preferred of >90° C., and particularly preferred of >110° C. It is further preferred in this context that the T_{g} is at least 30° C., more preferably at least 40° C. higher than the operational temperature of the electrolysis. With such a temperature setting, a sustainable process can be achieved.

It is preferred that in a use according to the present disclosure, the fluoropolymer membrane, more specifically the fluoropolymer comprised by and preferably constituting the membrane, comprises —(CF₂—CF₂)— repeat units. Such —(CF₂—CF₂)— repeat units may increase the resilience of the fluoropolymer membrane. An increased resilience can allow for HBr electrolysis at higher temperatures and at higher pressures, with may allow operation at higher current densities and/or at lower voltages, thereby making the inventive use more economical.

It is preferred that in a use according to the present disclosure, the fluoropolymer membrane, more specifically the fluoropolymer comprised by and preferably constituting the membrane, does not comprise structural entities of the formula —O—CF₂—CF(CF₃)—O—. Such structural entities are present in commercial membranes sold under the tradename Nafion®, but may lead to less rigidity of the membrane which is thus more prone to degradation at higher temperatures and higher pressures. Such membranes are therefore disfavoured according to the present disclosure.

It is preferred that in a use according to the present disclosure, the fluoropolymer membrane, more specifically the fluoropolymer comprised by and preferably constituting the membrane, comprises —CF₃ chain ends. Such —CF₃ chain ends may increase the resilience of the fluoropolymer membrane. An increased resilience can allow for HBr electrolysis at higher temperatures and at higher pressures, with may allow operation at higher current densities and/or at lower voltages, thereby making the inventive use more economical.

It is preferred that in a use according to the present disclosure, the fluoropolymer membrane is a sulfonated fluoropolymer membrane. More specifically, the fluoropolymer comprised by and preferably constituting the membrane is a sulfonated fluoropolymer. As used herein, sulfonated means that the fluoropolymer of the fluoropolymer membrane bears —SO₃H groups. Such —SO₃H groups can increase the proton conductivity of the fluoropolymer membrane, which can allow operation at higher current densities and/or at lower voltages, thereby making the inventive use more economical.

It is preferred that in a use according to the present disclosure, the sulfonated fluoropolymer membrane, more specifically the fluoropolymer comprised by and preferably constituting the membrane, comprises —O—(CF₂)ₙ—SO₃H groups, wherein n is an integer selected from 1, 2, 3, 4 and 5, preferably 2. Such —O—(CF₂)ₙ—SO₃H groups can help to achieve an increased proton conductivity of the fluoropolymer membrane while simultaneously increasing the resilience of the fluoropolymer membrane. An advantageous balance between these effects can in particular be obtained when n is selected from 1 to 5 and especially when n is 2. Without wishing to be bound to theory, it is assumed that the comparably short chain length of the —O—(CF₂)ₙ—SO₃H groups increases the glass transition temperature of the fluoropolymer membrane making it more resilient at higher temperatures. As such, the sulfonated fluoropolymer membrane is particularly advantageous from the viewpoint of HBr electrolysis at higher temperatures and/or at higher pressures, and hence at higher current densities and/or at lower voltages. As such, the sulfonated fluoropolymer membrane can make the inventive use particularly economical.

It is preferred that in a use according to the present disclosure, the sulfonated fluoropolymer membrane comprises a hydrolysed copolymer of F₂C═CF₂ and CF₂═CF—O—(CF₂)₂—SO₂F. Such a hydrolysed copolymer can lead to an increased proton conductivity and/or an increased resilience of the fluoropolymer membrane. As such, the sulfonated fluoropolymer membrane is particularly advantageous from the viewpoint of HBr electrolysis at higher temperatures and/or at higher pressures, and hence at higher current densities and/or at lower voltages. As such, the sulfonated fluoropolymer membrane can make the inventive use particularly economical.

It is preferred that in a use according to the present disclosure, the fluoropolymer membrane has an acid capacity of ≥0.9 meq/g, more preferred between 0.95 and 1.5 meq/g, and particularly preferred between 1.0 and 1.2 meq/g. As used herein, meq/g refers to milli-equivalent per gram, wherein the equivalent is mol —H (i.e., mol of H-acidic sites), preferably mol —SO₃H (i.e., mol of SO₃H-groups). The acid capacity represents the total of active sites or functional groups responsible for proton exchange of the fluoropolymer membrane. Such an acid capacity can increase the proton conductivity and can thereby lead to an increased HBr conversion in the HBr electrolysis. An increased HBr conversion may reduce any need for a separation and possible recirculation of unconverted HBr, which can help to maintain low CAPEX of the use according to the present disclosure.

It is preferred that in a use according to the present disclosure, the fluoropolymer membrane (in dry state) has a density of ≥1.70 g/cm³, more preferred of ≥1.80 g/cm³, still more preferred of ≥1.80 to ≤2.00 g/cm³ and particularly preferred of ≥1.90 to ≤1.95 g/cm³. The density of the fluoropolymer membrane can in particular be determined on a sample thereof according to ASTM D792-20. Such densities may increase the resilience of the fluoropolymer membrane. An increased resilience can allow for HBr electrolysis at higher temperatures and at higher pressures, with may allow operation at higher current densities and/or at lower voltages, thereby making the inventive use more economical.

It is preferred that in a use according to the present disclosure, the fluoropolymer membrane (in dry state) has a thickness of 25 to 350 μm, more preferred of 40 to 150 μm, still more preferred of 45 to 130 μm and particularly preferred of 45 to 55 μm. Such a thickness can achieve a balance between sufficient resilience on the one hand and CAPEX on the other hand. At a lower thickness, there is a risk of undesired crossover of hydrogen/bromine through the fluoropolymer membrane. At a higher thickness, an undesirable decrease in proton conductivity may result.

It is preferred that in a use according to the present disclosure, the fluoropolymer membrane (in dry state) has a tensile modulus of 100 to 500 MPa, more preferred of 150 to 400 MPa, still more preferred of 200 to 300 MPa and particularly preferred of 260 to 280 MPa. The tensile modulus of the fluoropolymer membrane can in particular be determined on a sample thereof according to ASTM D638-14. Such a tensile modulus may increase the resilience of the fluoropolymer membrane. An increased resilience can allow for HBr electrolysis at higher temperatures and at higher pressures, which may allow operation at higher current densities and/or at lower voltages, thereby making the inventive use more economical.

It is preferred that in a use according to the present disclosure, the fluoropolymer membrane (in dry state) has a tensile stress at break in the machine direction (MD), according to ASTM D882-18, of 10 to 70 MPa, more preferred of 20 to 60 MPa, still more preferred of 30 to 50 MPa and particularly preferred of 35 to 45 MPa. Such tensile stress at break in MD may increase the resilience of the fluoropolymer membrane. An increased resilience can allow for HBr electrolysis at higher temperatures and at higher pressures, which may allow operation at higher current densities and/or at lower voltages, thereby making the inventive use more economical.

It is preferred that in a use according to the present disclosure, the fluoropolymer membrane (in dry state) has a tensile stress at break in the cross direction (CD), according to ASTM D882-18, of 5 to 60 MPa, more preferred of 10 to 50 MPa, still more preferred of 20 to 40 MPa and particularly preferred of 25 to 35 MPa. Such tensile stress at break in CD may increase the resilience of the fluoropolymer membrane. An increased resilience can allow for HBr electrolysis at higher temperatures and at higher pressures, which may allow operation at higher current densities and/or at lower voltages, thereby making the inventive use more economical.

It is preferred that in a use according to the present disclosure, the fluoropolymer membrane (in dry state) has an elongation at break in machine direction (MD), according to ASTM D882-18, of 100 to 200%, more preferred of 120 to 180%, still more preferred of 140 to 160% and particularly preferred of 145 to 155%. Such an elongation at break in MD may increase the resilience of the fluoropolymer membrane. An increased resilience can allow for HBr electrolysis at higher temperatures and at higher pressures, which may allow operation at higher current densities and/or at lower voltages, thereby making the inventive use more economical.

It is preferred that in a use according to the present disclosure, the fluoropolymer membrane (in dry state) has an elongation at break in the cross direction (CD), according to ASTM D882-18, of 100 to 350%, more preferred of 120 to 300%, still more preferred of 150 to 250% and particularly preferred of 190 to 210%. Such an elongation at break in CD may increase the resilience of the fluoropolymer membrane. An increased resilience can allow for HBr electrolysis at higher temperatures and at higher pressures, which may allow operation at higher current densities and/or at lower voltages, thereby making the inventive use more economical.

It is preferred that in a use according to the present disclosure, a liquid phase is electrolysed in the electrolysis. In such a case, liquid streams are fed to both, the anode and the cathode of an electrolytic cell in which the liquid phase is electrolysed.

Electrolysing a liquid phase can lead to a safer production of hydrogen and bromine as no dangerous gaseous HBr may escape the electrolysis. Further, electrolysing a liquid phase can lead to easier handling of the resulting bromine as this is obtained as dissolved bromine.

It is preferred that in a use according to the present disclosure, an aqueous composition comprising hydrogen bromide is used as a feed for a cathode of an electrolytic cell in which the electrolysis of hydrogen bromide occurs. It is preferred that the aqueous composition (or feed) comprises ≥0.5 mol/kg hydrogen bromide, more preferably ≥1 mol/kg hydrogen bromide, still more preferably ≥2 mol/kg hydrogen bromide, even more preferably ≥3 mol/kg hydrogen bromide, further preferably ≥4 mol/kg hydrogen bromide, even further preferably ≥5 mol/kg hydrogen bromide, and most preferably ≥6 mol/kg hydrogen bromide, with mol/kg referring to mol of hydrogen bromide per kilogram of the aqueous composition. Feeding an aqueous composition comprising hydrogen bromide and in particular a highly concentrated aqueous hydrogen bromide composition to the cathode can decrease the operational voltage of the electrolytic cell, which can lead to reduced OPEX.

Further, in an HBr electrolysis, HBr is foremost to be fed to an anode of an electrolytic cell to achieve the desired electrolysis with bromine production at the anode and proton transfer to the cathode. When HBr is also fed to the cathode of the electrolytic cell, HBr is present on both sides of the cell which can suppress a disadvantageous boiling. Additionally, feeding the above-described highly concentrated aqueous hydrogen bromide composition to the cathode can also mitigate any problems associated with crossover of bromine species as of hydrogen bromide and/or Br₂ and/or Br ions (Br(—I) ions) from the anode to the cathode.

It is preferred that in a use according to the present disclosure, the electrolysis occurs at a temperature of 70° C. or more (operational temperature) and/or under a pressure of more than 0.1 MPa (operational pressure). It is preferred that the electrolysis occurs at a temperature of 80° C. or more and/or under a pressure of more than 0.15 MPa, still more preferred at a temperature of 90° C. or more and/or under a pressure of more than 0.2 MPa. Such electrolysis conditions can allow operation at higher current densities and/or at lower voltages, thereby making the inventive use more economical.

When the electrolysis occurs in the liquid state, that is, when a liquid phase is electrolysed in the electrolysis, an azeotropic mixture of HBr/H₂O is regularly fed to the anode of an electrolytic cell in which the electrolysis occurs (in which the electrolysis is performed). In such a case, it is preferred that the electrolysis occurs at higher temperatures, but below the boiling point of a fed azeotropic mixture of HBr/H₂O, more preferably at a temperature in the range of 70 to ≤122° C. (an azeotropic HBr/H₂O mixture of 48% HBr has a boiling point of about 122° C.) which allows using higher temperatures having the benefits described herein while keeping atmospheric pressure so that costs for increasing the pressure are avoided, making the inventive use overall more economical.

It is preferred that in a use according to the present disclosure, the pressure increases from an anode to a cathode of an electrolytic cell in which the electrolysis of hydrogen bromide occurs. Hence, there is a pressure gradient that increases from the anode to the cathode, wherein the respective pressures at the anode and the cathode have the same reference point, i.e., are either both absolute pressures, or are both gauge pressures relative to the atmosphere surrounding the electrolytic cell. In such a case, the electrolysis regularly occurs in the gaseous phase, i.e., feeding gaseous streams to the anode and the cathode. The pressure at the cathode is in such a case higher than the pressure at the anode, preferably higher by ≥0.01 MPa (i.e., the difference between the pressure at the cathode and the pressure at the anode is 0.01 or more MPa), more preferably higher by ≥0.02 MPa, still more preferably higher by ≥0.05 MPa, and most preferably higher by ≥0.1 MPa. As a preferred example, when the absolute pressure at the anode is 0.1 MPa, the absolute pressure at the cathode is 0.11 to 0.3 MPa, more preferably 0.12 to 0.25 MPa, still more preferably 0.15 to 0.2 MPa, and most preferably 0.2 MPa. However, optional pressures at the cathode which are higher than the pressure at the anode by 1 MPa, by 2 MPa, by 3 MPa, by 4 MPa, or even by 5 MPa are also contemplated. With such increasing pressures, or pressure gradients, reduced operational voltages of the electrolytic cell can be achieved, which can lead to reduced OPEX. Additionally, the pressure gradient may allow to obtain the H₂ at the cathode side at a higher pressure, so that no or less compression may be required subsequently for densifying the obtained H₂. Additionally, operation at differential pressure (the pressure increases from the anode to the cathode) can improve the operational parameters.

For the case when the anode feed is gas-phase HBr (either with or without a pressure gradient), it is preferred that the aqueous composition (or feed) sent to the cathode comprises ≤6 mol/kg hydrogen bromide, still more preferred ≤5 mol/kg hydrogen bromide, in particular, preferred ≤4 mol/kg hydrogen bromide, more particularly preferred ≤3 mol/kg hydrogen bromide, and most preferred ≤2 mol/kg hydrogen bromide. The beneficial effects of increased HBr concentrations at the cathode side on operational voltage may also be brought about when the anode feed is gaseous. However, care must be taken due to the risks of membrane damage at higher concentrations and simultaneously increased temperatures needed for the gas phase. Especially at higher temperatures thinner membranes may be prone to break. With the listed reduced HBr concentrations, a balance between the mentioned effects and risks can be achieved.

As afore-said, the sulfuric acid synthesis produces HBr which is electrolyzed according to the use of the present disclosure. It is preferred that in such a use according to the present disclosure, the sulfuric acid synthesis additionally converts nitrogen oxide (NOₓ) and/or ammonia (NH₃).

When the sulfuric acid is synthesized from sulfur oxide (SOₓ), the sulfur oxide may be accompanied by nitrogen oxide, for example nitrogen dioxide (NO₂). This can in particular be the case when the sulfur oxide stems from a flue gas. In such a case, the nitrogen oxide can be converted during the sulfuric acid synthesis. In this way, nitric acid may be additionally produced in the sulfuric acid synthesis, for example according to the following reaction: NO₂+H₂O+Br₂→HNO₃+HBr. Advantageously, the nitrogen oxide and in particular nitrogen dioxide, which is part of the otherwise lost flue gas, can thereby be valorised as it is transferred into more valuable compounds like nitric acid which can subsequently be used in other chemical processes. It is particularly preferred that the sulfuric acid synthesis additionally converts nitrogen dioxide into nitric acid.

When the sulfuric acid is synthesized from hydrogen sulphide (H₂S), the hydrogen sulphide may be accompanied by ammonia. In such a case, the ammonia can be converted during the sulfuric acid synthesis. Especially, nitrogen may be additionally produced in the sulfuric acid synthesis, for example according to the following reaction: 2NH₃+3Br₂→N₂+6HBr. It is thus particularly preferred that the sulfuric acid synthesis additionally converts ammonia into nitrogen. The conversion of ammonia into nitrogen can lead to an advantageous ammonia abatement.

It is preferred that in a use according to the present disclosure, the electrolysis occurs in the absence of hydrogen fluoride, hydrogen chloride, and/or hydrogen iodide. With hydrogen fluoride, hydrogen chloride, and/or hydrogen iodide being absent, the purity of the produced H₂ and/or Br₂ can be improved. Further, fluctuations of the operational voltage can be avoided, which may reduce any need for regulating the HBr electrolysis.

The subject of the disclosure is also hydrogen obtained by an inventive use as described herein. The preferred embodiments of the use described herein including the claims are likewise preferred for this inventive hydrogen in an analogous manner. With such an inventive use, advantageously pure hydrogen can be accessible through HBr electrolysis. With such an inventive use, hydrogen useful for example for fuel synthesis can be accessible through HBr electrolysis which can thereby assist in mitigating global warming.

The subject of the disclosure is also bromine obtained by an inventive use as described herein. The preferred embodiments of the use described herein including the claims are likewise preferred for this inventive bromine in an analogous manner. With such an inventive use, advantageously pure bromine can be accessible through HBr electrolysis. With such an inventive use, bromine useful in subsequent chemical synthesis can be accessible through HBr electrolysis which can thereby assist in closing the bromine loop.

In another aspect of the disclosure is also a method of producing hydrogen and/or bromine by electrolysing hydrogen bromide using a fluoropolymer membrane having a glass transition temperature T_{g}≥110° C., wherein the hydrogen bromide stems from a sulfuric acid synthesis. The preferred embodiments of the use described herein including the claims are likewise preferred for this inventive method in an analogous manner.

Preferably, in one aspect, the method of producing hydrogen and/or bromine by electrolysing hydrogen bromide comprises the following steps:
i) synthesizing sulfuric acid such that hydrogen bromide is produced,
ii) providing an electrolytic cell comprising an anode, a cathode, and a fluoropolymer membrane having a glass transition temperature T_{g} equal to or greater than 110° C. as determined according to DIN EN ISO 11357-2:2020-08, the fluoropolymer membrane being sandwiched between the anode and the cathode,
iii) feeding a first composition comprising hydrogen bromide and water to the anode,
iv) feeding a second composition comprising hydrogen bromide and water to the cathode, and
v) operating the electrolytic cell to produce hydrogen at the cathode and/or bromine at the anode,
   wherein the hydrogen bromide fed in step iii) and/or the hydrogen bromide fed in step iv) is hydrogen bromide produced in step i).

More particularly, the disclosure concerns a method of producing hydrogen and/or bromine by electrolysing hydrogen bromide comprises the following steps:
i) synthesizing sulfuric acid such that hydrogen bromide is produced,
ii) providing an electrolytic cell comprising an anode, a cathode, and a fluoropolymer membrane having a glass transition temperature T_{g} equal to or greater than 110° C. as determined according to DIN EN ISO 11357-2:2020-08, the fluoropolymer membrane being sandwiched between the anode and the cathode,
iii) feeding a first composition comprising hydrogen bromide and water to the anode,
iv) feeding a second composition comprising hydrogen bromide and water to the cathode, and
v) operating the electrolytic cell at an operation voltage of at most 1900 mV and at an operation current density of at least 3 kA/m² to produce hydrogen at the cathode and/or bromine at the anode,
wherein the hydrogen bromide produced in step i) is used to prepare the first composition fed in step iii) or both the first composition and the second composition fed in steps iii) and iv).

In another aspect, the method of producing hydrogen and/or bromine by electrolysing hydrogen bromide comprises the following steps:
i) providing a stream containing hydrogen bromide obtained from the synthesis of sulfuric acid,
ii) providing an electrolytic cell comprising an anode, a cathode, and a fluoropolymer membrane having a glass transition temperature T_{g} equal to or greater than 110° C. as determined according to DIN EN ISO 11357-2:2020-08, the fluoropolymer membrane being sandwiched between the anode and the cathode,
iii) feeding a first composition comprising hydrogen bromide and water to the anode,
iv) feeding a second composition comprising hydrogen bromide and water to the cathode, and
v) operating the electrolytic cell to produce hydrogen at the cathode and/or bromine at the anode,
   wherein the stream containing hydrogen bromide provided in step i) is used to prepare the first composition fed in step iii) or both the first composition and the second composition fed in steps iii) and iv)

More particularly, the method of producing hydrogen and/or bromine by electrolysing hydrogen bromide comprises the following steps:
i) providing a stream containing hydrogen bromide obtained from the synthesis of sulfuric acid,
ii) providing an electrolytic cell comprising an anode, a cathode, and a fluoropolymer membrane having a glass transition temperature T_{g} equal to or greater than 110° C. as determined according to DIN EN ISO 11357-2:2020-08, the fluoropolymer membrane being sandwiched between the anode and the cathode,
iii) feeding a first composition comprising hydrogen bromide and water to the anode,
iv) feeding a second composition comprising hydrogen bromide and water to the cathode, and
v) operating the electrolytic cell at an operation voltage of at most 1900 mV and at an operation current density of at least 3 kA/m² to produce hydrogen at the cathode and/or bromine at the anode,
   wherein the stream containing hydrogen bromide provided in step i) is used to prepare the first composition fed in step iii) or both the first composition and the second composition fed in steps iii) and iv)

Such a method of producing hydrogen and/or bromine by electrolysing hydrogen bromide allows to considerably decrease the energy consumption, notably thanks to the use of a specific fluoropolymer membrane along with specific operating conditions. This is demonstrated by the general reduction of operational expenditures (OPEX).

For example, step v) of operating the electrolyte cell comprises an operational voltage (Uₒₚ) of at most 1800 mV; preferably at most 1700 mV; more preferably of at most 1600 mV, and even more preferably of at most 1500 mV.

For example, step v) of operating the electrolyte cell comprises an operational voltage (Uₒₚ) from 400 to 1900 mV, preferably from 500 to 1800 mV; more preferably from 600 to 1700 mV; even more preferably from 700 to 1600 mV, and most preferably from 800 to 1500 mV.

For example, step v) of operating the electrolyte cell comprises an operational current density (Jₒₚ) of at least 4 kA/m²; preferably of at least 5 kA/m². In an embodiment, step v) of operating the electrolyte cell comprises an operational current density (Jₒₚ) of at least 6 kA/m²; preferably of at least 7 kA/m²; more preferably of at least 8 kA/m²; even more preferably of at least 9 kA/m²; and most preferably of at least 10 kA/m².

For example, step v) of operating the electrolyte cell comprises an operational current density (Jₒₚ) of at most 12 kA/m²; preferably of at most 11 kA/m².

For example, step v) of operating the electrolyte cell comprises an operational current density (Jₒₚ) ranging from 3 kA/m² to 15 kA/m²; preferably from 4 kA/m² to 12 kA/m² or from 5 kA/m² to 12 kA/m². In an embodiment, step v) of operating the electrolyte cell comprises an operational current density (Jₒₚ) ranging from 6 kA/m² to 12 kA/m²

For example, the temperature of the first composition fed to the anode is at least or above 60° C., and simultaneously the temperature of the second composition fed to the cathode is at least or above 60° C. Preferably, the temperature of the first composition fed to the anode is at least or above 65° C. and simultaneously the temperature of the second composition fed to the cathode is at least or above 65° C. More preferably, the temperature of the first composition fed to the anode is at least or above 70° C., and simultaneously the temperature of the second composition fed to the cathode is at least or above 70° C.

For example, the fluoropolymer membrane has a glass transition temperature T_{g} equal to or greater than 112° C. as determined according to DIN EN ISO 11357-2:2020-08; preferably equal to or greater than 115° C.; more preferably equal to or greater than 118° C.; even more preferably equal to or greater than 120° C.; most preferably equal to or greater than 122° C.; and even most preferably equal to or greater than 125° C.

For example, the fluoropolymer membrane has a glass transition temperature T_{g} equal to or lower than 170° C. as determined according to DIN EN ISO 11357-2:2020-08; preferably equal to or lower than 168° C.; more preferably equal to or lower than 165° C.; even more preferably equal to or lower than 162° C.; most preferably equal to or lower than 160° C.

For example, the fluoropolymer membrane has a glass transition temperature T_{g} in the range of 120 to 170° C., as determined according to DIN EN ISO 11357-2:2020-08.

For example, the fluoropolymer membrane comprises —(CF₂—CF₂)— repeat units.

For example, the fluoropolymer membrane does not comprise structural entities of the formula —O—CF₂—CF(CF₃)—O—.

For example, the fluoropolymer membrane is a sulfonated fluoropolymer membrane. For example, the sulfonated fluoropolymer membrane comprises —O—(CF₂)ₙ—SO₃H groups, wherein n is an integer selected from 1, 2, 3, 4, and 5, preferably 2. For example, the sulfonated fluoropolymer membrane comprises a hydrolysed copolymer of F₂C═CF₂ and CF₂═CF—O—(CF₂)₂—SO₂F.

For example, the fluoropolymer membrane has an acid capacity of equal to or greater than 0.9 meq/g; preferably, equal to or greater than 0.95 meq/g; more preferably, equal to or greater than 1.0 meq/g.

For example, the fluoropolymer membrane has an acid capacity ranging between 0.9 and 1.5 meq/g; preferably between 0.95 and 1.5 meq/g; more preferably between 1.0 and 1.4 meq/g; even more preferably, between 1.0 and 1.3 meq/g; and most preferably between 1.0 and 1.2 meq/g. As used herein, meq/g refers to milli-equivalent per gram, wherein the equivalent is mol —H (i.e., mol of H-acidic sites), preferably mol —SO₃H (i.e., mol of SO₃H-groups).

For example, the electrolysis occurs at a temperature of 70° C. or more; preferably at a temperature of 75° C. or more, more preferably at a temperature of 80° C. or more; even more preferably, at a temperature of 85° C. or more; and most preferably, at a temperature of 90° C. or more.

For example, the electrolysis occurs at a temperature of less than 122° C.; preferably at a temperature of 120° C. or less, more preferably at a temperature of 115° C. or less; even more preferably, at a temperature of 110° C. or less; most preferably, at a temperature of 105° C. or less; even most preferably, at a temperature of 100° C. or less or at a temperature of 95° C. or less.

For example, the electrolysis occurs at a temperature ranging from 70 to 122° C.; preferably, from 70° C. to 120° C. or less: more preferably, from 75° C. to 115° C.; even more preferably, from 80° C. to 110° C.; most preferably, from 85° C. to 105° C.; even most preferably, from 90° C. to 100° C.; or from 80° C. to 95° C.; or from 75 to 95° C.

For example, the electrolysis occurs under a pressure of more than 0.1 MPa; preferably more than 0.15 MPa; more preferably more than 0.2 MPa.

For example, the pressure increases from an anode to a cathode of an electrolytic cell in which the electrolysis of hydrogen bromide occurs.

For example, the electrolysis occurs in the absence of hydrogen fluoride, hydrogen chloride, and/or hydrogen iodide.

For example, the second composition comprises a hydrogen bromide concentration of at least 0.5 mol/kg; preferably, at least 1 mol/kg; more preferably, at least 2 mol/kg; even more preferably, at least 3 mol/kg; most preferably at least 4 mol/kg; even most preferably at least 5 mol/kg or at least 6 mol/kg.

For example, the second composition comprises a hydrogen bromide concentration of at most 12 mol/kg; preferably, at most 10 mol/kg; more preferably, at most 9 mol/kg; even more preferably, at most 8 mol/kg; and most preferably most 7 mol/kg.

For example, the second composition comprises a hydrogen bromide concentration ranging from 0.5 to 12 mol/kg; preferably from 0.5 to 10 mol/kg; more preferably, preferably from 1 to 10 mol/kg; even more preferably, from 2 to 9 mol/kg; most preferably from 3 to 9 mol/kg; even most preferably from 4 to 9 mol/kg; or from 5 to 8 mol/kg; or from 3 to 7 mol/kg.

For example, the fluoropolymer membrane is selected to have a glass transition temperature of at least 30° C. higher than the operational temperature of the electrolysis; preferably higher than 35° C.; and more preferably higher than 40° C.

In the method according to the present disclosure, an electrolytic cell comprises two electrodes, namely the anode and the cathode, between which an electric field can be applied. For this, the anode and the cathode regularly comprise electroconductive material, especially metal, coated metal, carbon cloth, graphite felt, carbon fibre composite, carbon loaded polymer, or graphite, and are preferably made of carbon fibre composite or coated metal. HBr forms a very corrosive environment but the mentioned electroconductive materials can regularly withstand such a corrosive environment and are hence preferred.

In the method according to the present disclosure, the membrane sandwiched between the anode and the cathode is a membrane having two opposing surfaces, with the anode being provided on one of the two opposing surfaces and the cathode being provided on the other one of the two opposing surfaces.

In the method according to the present disclosure, a composition comprising hydrogen bromide and water is an aqueous composition in which HBr is dissolved in water. This is true for the first composition and the second composition. The HBr dissolved in water will regularly be dissociated in the water such that the (first, second) composition will regularly comprise ionic species, especially H⁺, H₃O⁺, and Br⁻. The first and/or second composition can both be present in a liquid state, or can both be present in a gaseous state. It is also possible that the first composition is present in a liquid state, while the second composition is present in a gaseous state. It is also possible that the second composition is present in a liquid state, while the first composition is present in a gaseous state.

According to step v) of the method, the electrolytic cell is operated to produce hydrogen at the cathode. Logically, this requires applying an electric field to the anode and the cathode. Alternatively, it can be said that an operational voltage has to be applied to the electrolytic cell. It can therefore be said that a method according to the present disclosure, which can alternatively be named electrolysis of hydrogen bromide or HBr electrolysis, refers to an electrolytic split of HBr into hydrogen and a bromine species by applying an electric field, or an operational voltage, to the anode and the cathode.

For electrolysis of HBr, it is required to feed HBr to an anode of an electrolytic cell where protons are generated. The protons then migrate to a cathode, in the present case migrate through the sandwiched membrane to the cathode. For the method according to the present disclosure, it is surprisingly advantageous to feed HBr also to the cathode, namely a composition having a hydrogen bromide concentration of ≥1 mol/kg. With such an HBr feed to the cathode, it can be possible to operate the electrolytic cell at a lower operational voltage. A lower operational voltage reduces the OPEX of the method and thus makes the HBr electrolysis more economical. Further with such an HBr feed to the cathode, it can be possible to operate the electrolytic cell at higher temperatures which lowers cooling and/or heating requirements. The lowered cooling/heating requirements also reduce the OPEX of the method and thus also make the HBr electrolysis more economical. Additionally, with such an HBr feed to the cathode, it can be possible to operate the electrolytic cell at higher current densities. Higher current densities reduce the CAPEX of the method and thus make the HBr electrolysis more economical. Moreover, the method according to the present disclosure may produce hydrogen in an eco-friendly manner, thereby assisting in mitigating global warming.

Further, feeding of HBr on the cathode side can reduce the concentration gradient across the membrane and can reduce or even mitigate the undesirable transfer of HBr and/or Br₂ and/or Br from the anode to the cathode through the membrane. Additionally, the presence of HBr on the cathode side may allow HBr to cross through the membrane from the cathode to the anode side. This results in a global increase in the efficiency of the system and allows avoiding any perturbation during electrolysis. Without wishing to be bound to theory, it is assumed that in the inventive method, there is actually HBr crossing in the reverse direction, i.e., from the cathode to the anode. Such an HBr crossing in the reverse direction is considered to be one of the reasons why the efficiency of the inventive method can be increased.

It is preferred that in a method according to the present disclosure, the hydrogen bromide concentration of the second composition fed to the cathode is ≥0.5 mol/kg, more preferably ≥1 mol/kg, still more preferably ≥2 mol/kg, even more preferably ≥3 mol/kg, further preferably ≥4 mol/kg, even further preferably ≥5 mol/kg, and most preferably ≥6 mol/kg, with mol/kg referring to mol of hydrogen bromide per kilogram of the second composition. All the above-mentioned effects of the second composition comprising hydrogen bromide and water being fed to the cathode can be increasingly more pronounced when the hydrogen bromide concentration of the second composition is increasingly higher, namely when the hydrogen bromide concentration of the second composition is increasing from the preferred concentration of ≥0.5 mol/kg up to the most preferred concentration of ≥6 mol/kg.

Herein, hydrogen bromide concentrations are regularly given in mol/kg, i.e., in mol HBr per kg composition (or solution). HBr has a molecular weight of 80.91 g/mol. Accordingly, a hydrogen bromide concentration (CHBr) of the second composition of for example ≥1 mol/kg can alternatively be expressed as ≥80.91 g/kg, i.e.,≥80.91 g of HBr per kg of composition. The same conversion can be made for any concentration referred to herein.

It is preferred that in a method according to the present disclosure, the electrolytic cell is operated in step v) at an operational voltage Uₒₚ≤1900 mV, preferably at an operational voltage Uₒₚ≤1700 mV (but above 0 mV, i.e., Uₒₚ>0 mV). Operating the electrolytic cell at such an operational voltage can improve the selectivity of the reaction towards HBr electrolysis and hereby reduce the OPEX of the method and can thus make the HBr electrolysis more economical.

It is preferred that in a method according to the present disclosure, the electrolytic cell is operated in step v) at an operational temperature Tₒₚ≥70° C., wherein Tₒₚ is below the boiling point of the second composition, preferably at an operational temperature 70° C.≤Tₒₚ≤122° C. Operating the electrolytic cell at such an operational temperature can lower cooling and/or heating requirements. In particular, the HBr is a side product of a sulfuric acid synthesis. Such HBr is typically hot and would regularly have to be cooled down for a subsequent electrolysis thereof. Performing the electrolysis at an operational temperature Tₒₚ≥70° C. reduces the need for such cooling down.

Additionally, higher temperatures typically increase the proton conductivity of a fluoropolymer-comprising membrane, which can allow operation at higher current densities and/or at lower voltages. Higher current densities help to keep the CAPEX low. In this context, it is preferred that the electrolysis is performed at or above 70° C. (≥70° C.). At such temperatures, liquid-liquid phase separation can be avoided. It is thus particularly preferred that the operational temperature Tₒₚ is maintained at >70° C., more specifically at >90° C., especially at >100° C.

Additionally, operational temperatures of Tₒₚ≥70° C., but below the boiling point of the second composition, can decrease the resistance of the membrane which can allow for higher proton conductivities. Higher proton conductivities can allow for higher current densities at lower operational voltages. Higher current densities can help to keep CAPEX low, while lower operational voltages can lead to lower OPEX, thereby making the method of electrolysing hydrogen bromide according to the present disclosure particularly economical. At the same time, a boiling of the second composition can be prevented so that no gaseous HBr is formed, especially no gaseous HBr which might escape to the environment. This can help to run the method according to the present disclosure in a safe manner. All these effects related to the operational temperature can be even more pronounced when the operational temperature is 70° C. ≤Tₒₚ≤122° C.

It is preferred that in a method according to the present disclosure, the first composition and the second composition are both a liquid composition. Such a method can also be termed an electrolysis in aqueous phase. With the first composition and the second composition both being liquid composition, formation of gaseous HBr can be suppressed, so that no such dangerous gaseous HBr can escape to the environment. This can help to run the method of electrolysing hydrogen bromide in a particularly safe manner.

It is preferred that in a method according to the present disclosure, the first composition and the second composition are both a liquid composition which has an operational temperature above 60° C., still more preferably an operational temperature above 70° C. That is, it is preferred that the temperature of the first composition fed to the anode is >60° C. and simultaneously the temperature of the second composition fed to the cathode is >60° C., and it is more preferred that the temperature of the first composition fed to the anode is >70° C. and simultaneously the temperature of the second composition fed to the cathode is >70° C. As aforesaid, Br₂ solubility in water is rather limited, but Br₂ is perfectly soluble in HBr in the form of Br₃⁻, and as soon as ≥33% of Br is present in the form of HBr, merely one phase and no inhomogeneity are observed in the electrolytic cell. One of the objects of the present disclosure is Br₂ recovery, and a further object is H₂ production for which a high conversion level per pass is desirable. In aqueous phase at low temperatures, it is typically not possible to achieve a conversion level above 67% of HBr per pass without any phase separation and without adversely effecting the performance of the electrolytic cell, in particular not below the boiling temperature of Br₂ (58.8° C.). As also aforesaid, preferably above 60° C., more preferably above 70° C., Br₂ evaporates sufficiently fast, thereby preventing the formation of a second liquid phase at a high conversion level.

For a preferred electrolysis in aqueous phase, i.e., when feeding the first composition and the second composition both as a liquid composition at above 60° C., more preferably at above 70° C., fluoropolymer membranes having a significantly higher T_{g} are preferred, inter alia from the viewpoint of a sustainable electrolysis. Hence, for such a case it is preferred that the T_{g} of the fluoropolymer membrane is at least 30° C. and more preferably 40° C. higher than the operational temperature of the electrolysis, i.e., the temperature of the first and/or second composition, preferably the temperature of the first and the second composition. Such a temperature setting can lead to a particularly sustainable HBr electrolysis.

It is preferred that the electrolytic cell is operated in step v) at least partially at an operational pressure pₒₚ>0.1 MPa. With such an increased operational pressure, reduced operational voltages of the electrolytic cell may be achieved, which can lead to reduced OPEX. Additionally, the increased operational pressure may allow obtaining the H₂ at the cathode side at a higher pressure, so that no or less compression may be required subsequently for densifying the obtained H₂.

It is preferred that in a method according to the present disclosure, the electrolytic cell is operated in step v) at an operational current density Jₒₚ≥3 kA/m², preferably at an operational current density Jₒₚ≥5 kA/m². With such increased current densities, it can be possible to lower the CAPEX of the method of electrolysing hydrogen bromide, thereby making the method more economical.

### BRIEF DESCRIPTION OF THE DRAWINGS

FIG. 1 shows the general outline of an electrolysis cell that is applicable for a use according to the present disclosure.

FIG. 2 shows the temperature dependence of the voltage of HBr electrolyses.

FIG. 3 shows the results of HBr electrolyses using different membranes.

FIG. 4 shows the results of further HBr electrolyses with different membrane types.

FIG. 5 is a scheme with different routes for producing hydrogen bromide in a sulfuric acid synthesis.

FIG. 6 is a scheme with a typical reaction sequence yielding valuable hydrogen by converting a sulfur(S)-containing and potentially nitrogen(N)-containing feedstream via an oxidation with bromine.

### EXPERIMENTAL SECTION

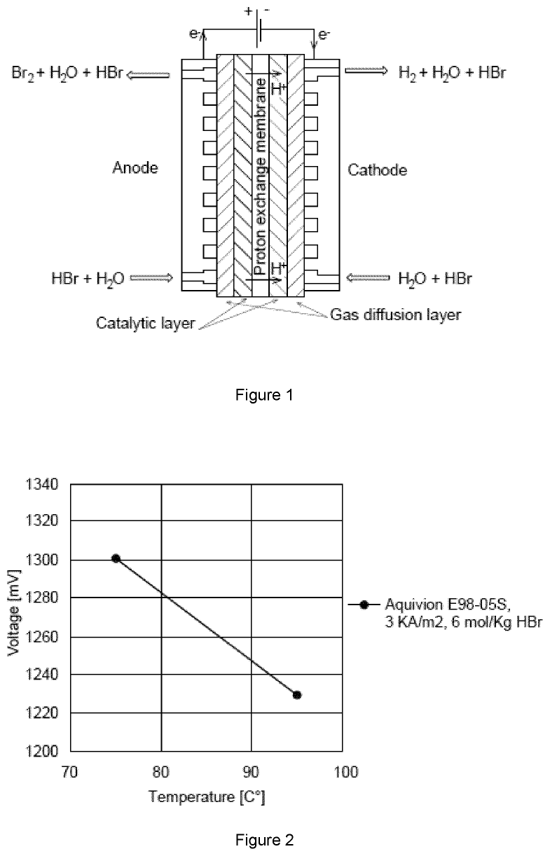

FIG. 1 is a general outline of an exemplary electrolysis cell and an exemplary electrolysis procedure, respectively, which can be employed to put a use according to the present disclosure into practice. The proton exchange membrane depicted in FIG. 1 is a fully hydrated fluoropolymer membrane having a glass transition temperature T_{g}≥110° C., for example a fully hydrated Aquivion® E98-05S membrane or a fully hydrated Aquivion® E87-05S membrane. The membrane is sandwiched between two catalytic layers. The catalytic layers themselves are sandwiched between two gas diffusion layers. On the left-hand side, an anode is arranged on a first gas diffusion layer, namely on the surface opposite to the surface on which a first catalytic layer is arranged. On the right-hand side, a cathode is arranged on a second gas diffusion layer, namely on the surface opposite to the surface on which a second catalytic layer is arranged. A first mixture comprising HBr and H₂O is fed to the anode, while a second mixture also comprising HBr and H₂O is fed to the cathode. The HBr fed to the anode as well as the HBr fed to the cathode stems from a synthesis of H₂SO₄ according to SO₂+Br₂+2H₂O→H₂SO₄+2HBr. An electric field is applied to the electrolysis cell such that electrons (e⁻) are transferred from the anode to the cathode. At the anode, HBr migrates through the anode gas diffusion layer to the anode catalytic layer where it is electrooxidized so that Br₂ is formed and protons are remaining. The protons migrate from the anode catalytic layer through the membrane to the cathode catalytic layer. At the cathode catalytic layer, the protons recombine with electrons to H₂. Formed H₂ migrates through cathode gas diffusion layer. As electrolysis products, a stream comprising Br₂ and H₂O is withdrawn from the anode, and a stream comprising H₂, H₂O, and HBr is withdrawn from the cathode. The stream withdrawn from the anode may additionally comprise unconverted HBr.

FIG. 2 shows the results of actual electrolyses of HBr using an Aquivion® E98-05S membrane at different temperatures. A successful electrolysis was performed at elevated temperatures of 75° C. up to 95° C. without any indication of a degrading of the membrane despite using a highly concentrated HBr feed having an HBr concentration of 6 mol/kg as the anode feed. The operational voltage decreased from 1301 mV at a temperature of 75° C. to 1230 mV at a temperature of 95° C., keeping a current density of 3 kA/m². The increase to higher temperatures thus led to an advantageous reduction of the to be invested voltage at a constantly high current density of 3 kA/m², which in turn led to advantageously lowered OPEX.

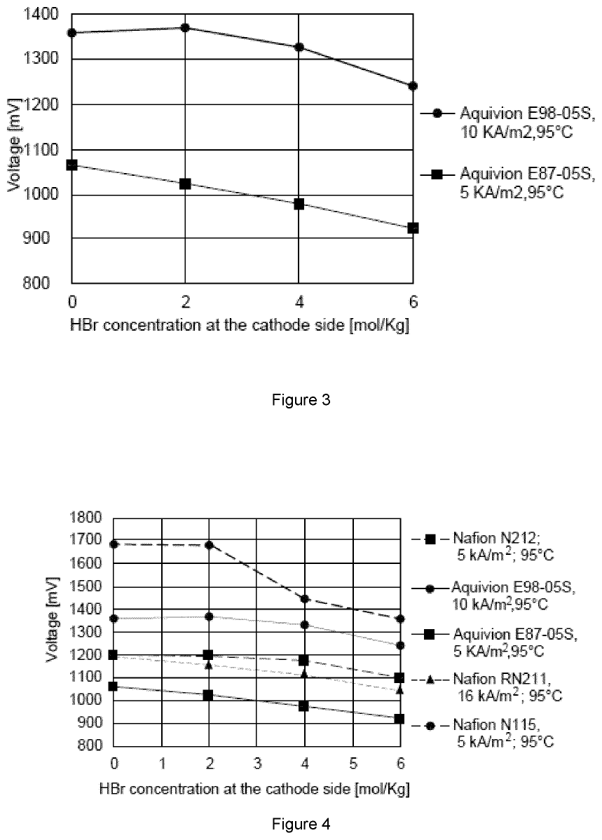

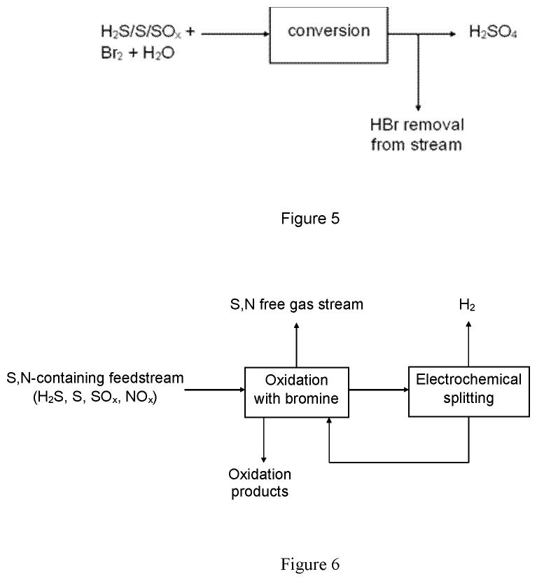

FIG. 3 shows the results of actual electrolyses of HBr using two different membranes and current densities, namely an Aquivion® E98-05S membrane at a current density of 10 kA/m² and an Aquivion® E87-05S membrane at a current density of 5 kA/m². Further, the HBr concentration of an aqueous HBr solution fed to the cathode of the electrolysis cell was increased from 0 mol/kg (deionized water) over 2 mol/kg and further 4 mol/kg up to 6 mol/kg. It is seen that successful electrolyses were performed at an elevated temperature of 95° C. and at high current densities of 5 kA/m² and even 10 kA/m² without any indication of a degrading of the membrane. Moreover, feeding a highly concentrated aqueous HBr solution to the cathode did not impair the membrane performance. Instead, with the exception of a minor outlier at 2 mol/kg for the Aquivion® E98-05S membrane, increasing the HBr concentration surprisingly led to a significant lowering of the operational voltage which in turn led to advantageously lowered OPEX.

FIG. 4 shows the results of actual electrolyses of HBr using different current densities and different membranes. Comparing the results obtained with 2 NAFION membranes at 5kA/m2 and 95° C. with the Aquivion membrane in the same conditions, it can be seen that the operational voltage is lower for Aquivion, resulting in a lower OPEX.

1. A method of producing hydrogen and/or bromine by electrolysing hydrogen bromide comprises the following steps:
i) synthesizing sulfuric acid such that hydrogen bromide is produced,
ii) providing an electrolytic cell comprising an anode, a cathode, and a fluoropolymer membrane having a glass transition temperature T_{g} equal to or greater than 110° C. as determined according to DIN EN ISO 11357-2:2020-08, the fluoropolymer membrane being sandwiched between the anode and the cathode,
iii) feeding a first composition comprising hydrogen bromide and water to the anode,
iv) feeding a second composition comprising hydrogen bromide and water to the cathode, and
v) operating the electrolytic cell at an operation voltage of at most 1900 mV and at an operation current density of at least 3 kA/m² to produce hydrogen at the cathode and/or bromine at the anode,
wherein the hydrogen bromide produced in step i) is used to prepare the first composition fed in step iii) or both the first composition and the second composition fed in steps iii) and iv)

2. A method of producing hydrogen and/or bromine by electrolysing hydrogen bromide comprises the following steps:
i) providing a stream containing hydrogen bromide obtained from the synthesis of sulfuric acid,
ii) providing an electrolytic cell comprising an anode, a cathode, and a fluoropolymer membrane having a glass transition temperature T_{g} equal to or greater than 110° C. as determined according to DIN EN ISO 11357-2:2020-08, the fluoropolymer membrane being sandwiched between the anode and the cathode,
iii) feeding a first composition comprising hydrogen bromide and water to the anode,
iv) feeding a second composition comprising hydrogen bromide and water to the cathode, and
v) operating the electrolytic cell at an operation voltage of at most 1900 mV and at an operation current density of at least 3 kA/m² to produce hydrogen at the cathode and/or bromine at the anode,
wherein the stream containing hydrogen bromide provided in step i) is used to prepare the first composition fed in step iii) or both the first composition and the second composition fed in steps iii) and iv)

3. The method according to claim 1 is characterized in that step v) of operating the electrolyte cell comprises an operational voltage of at most 1500 mV; or from 800 to 1500 mV.

4. The method according to claim 1 is characterized in that step v) of operating the electrolyte cell comprises an operational current density of at least 4 kA/m² or from 4 kA/m² to 12 kA/m².

5. The method according to claim 1 is characterized in that the temperature of the first composition fed to the anode is at least or above 60° C. and simultaneously the temperature of the second composition fed to the cathode is at least or above 60° C.

6. The method according to claim 1 is characterized in that the fluoropolymer membrane has a glass transition temperature T_{g} in the range of 120 to 170° C., as determined according to DIN EN ISO 11357-2:2020-08.

7. The method according to claim 1 is characterized in that the fluoropolymer membrane comprises —(CF₂—CF₂)— repeat units.

8. The method according to claim 1 is characterized in that the fluoropolymer membrane does not comprise structural entities of the formula —O—CF₂—CF(CF₃)—O—.

9. The method according to claim 1 is characterized in that the fluoropolymer membrane is a sulfonated fluoropolymer membrane.

10. The method according to claim 9 is characterized in that the sulfonated fluoropolymer membrane comprises —O—(CF₂)ₙ—SO₃H groups, wherein n is an integer selected from 1, 2, 3, 4 and 5, preferably 2.

11. The method according to claim 9 is characterized in that the sulfonated fluoropolymer membrane comprises a hydrolysed copolymer of F₂C═CF₂ and CF₂═CF—O—(CF₂)₂—SO₂F.

12. The method according to claim 1 is characterized in that the fluoropolymer membrane has an acid capacity of equal to or greater than 0.9 meq/g.

13. The method according to claim 1 is characterized in that electrolysis occurs at a temperature of 70° C. or more and/or in that electrolysis occurs at a temperature of less than 100° C.

14. The method according to claim 1 is characterized in that electrolysis occurs at a temperature ranging from 75 to 95° C.

15. The method according to claim 1 is characterized in that electrolysis occurs under a pressure of more than 0.1 MPa.

16. The method according to claim 1 is characterized in that the pressure increases from an anode to a cathode of an electrolytic cell in which the electrolysis of hydrogen bromide occurs.

17. The method according to claim 1 is characterized in that the electrolysis occurs in the absence of hydrogen fluoride, hydrogen chloride, and/or hydrogen iodide.

18. The method according to claim 1 is characterized in that the second composition comprises a hydrogen bromide concentration of at least 0.5 mol/kg; preferably at least 3 mol/kg.

19. The method according to claim 1 is characterized in that the second composition comprises a hydrogen bromide concentration ranging from 0.5 to 10 mol/kg; preferably from 3 to 7 mol/kg.

20. The method according to claim 1 is characterized in that the fluoropolymer membrane is selected to have a glass transition temperature of at least 30° C. higher than the operational temperature of the electrolysis; preferably higher than 40° C.
